(19) United States
(12) Patent Application Publication
(10) Pub. No.: US 2003/0131357 A1
(43) Pub. Date: Jul. 10, 2003

(54) Method and apparatus for displaying additional information linked to digital TV program

(75) Inventor: Kyung-ah Kim, Seoul (KR)

Correspondence Address: SUGHRUE MION, PLLC, 2100 Pennsylvania Avenue, NW, Washington, DC, 20037-3213, US

(73) Assignee: Samsung Electronics Co., Ltd.

(21) Appl. No.: 10/303,058

(22) Filed: Nov. 25, 2002

(30) Foreign Application Priority Data
Jan. 7, 2002 (KR) 2002-706

(51) Int. Cl. G06F 3/00; H04N 5/445; G06F 13/00; H04N 7/173; H04N 7/16

(52) U.S. Cl. 725/60; 725/112; 725/136

(57) ABSTRACT

A method and apparatus for displaying product information linked to a digital TV program are provided. The method for displaying product information linked to a digital TV program includes the steps of (a) displaying an AV scene of the digital TV program, (b) displaying a first icon overlapping the AV scene if there is product information linked to the current AV scene, and (c) if the first icon is clicked on, displaying a first product information scene in which a reduced AV scene which is reduced from the AV scene, linked product information, and a second icon for product information linked to the previously displayed AV scene. Thus, a user can use a user-friendly interface for additional information linked to the digital TV program. Furthermore, product information on an object which was already broadcast can be watched later.

### BACKGROUND OF THE INVENTION

This application claims the priority of Korean Patent Application No. 2002-000706, filed Jan. 7, 2002, which is incorporated herein in its entirety by reference.

1. Field of the Invention

The present invention relates to a method and apparatus for displaying additional information linked to a digital TV program.

2. Description of the Related Art

A digital TV program is broadcast through a Moving Picture Experts Group (MPEG) system. The MPEG system removes redundancy in each frame or continuous frames, divides each frame into a plurality of blocks, Discrete Cosine Transform (DCT) processes each block, and compresses the blocks. The compressed data is packed as a variety of data packets, including a video packet, an audio packet, an additional data packet, and a navigation packet, and the packets are multiplexed and then transmitted. The additional data packet is defined to contain additional information. The navigation packet is defined to contain information needed in reproducing the video packet, the audio packet, and the additional data packet. Thus, digital TV broadcasting specifications define additional information related to a digital TV program.

### SUMMARY OF THE INVENTION

It is an objective of the present invention to provide a method and apparatus for displaying additional information linked to a digital TV program.

It is another objective of the present invention to provide a method and apparatus for providing a user-friendly interface to additional information linked to a digital TV program.

It is another objective of the present invention to provide a method and apparatus for storing additional information linked to a digital TV program and watching the information later when desired.

To accomplish the objectives of the present invention, there is provided a method for displaying product information linked to a digital TV program comprising the steps of (a) extracting and storing the product information, and (b) displaying the stored product information in response to a user request.

It is preferable that step (a) comprises the steps of (a1) receiving and displaying the digital TV program, and (a2) storing product information linked to the digital TV program displayed in step (a1) in response to the user request.

It is also preferable that step (b) further comprises the step of (b1) displaying stored product information and a linked AV scene together.

It is also preferable that the product information includes image information and purchase information of the corresponding product.

To accomplish the objectives of the present invention, there is provided a method for displaying product information linked to a digital TV program comprising the steps of (a) displaying an AV scene of the digital TV program, (b) displaying a first icon overlapping the AV scene if there is product information linked to the current AV scene, and (c) if the first icon is clicked on, displaying a first product information scene in which a reduced AV scene which is reduced from the AV scene, linked product information, and a second icon for product information linked to the previously displayed AV scene.

It is preferable that the method further comprises the step of (d) if the second icon is clicked on, displaying a second product information scene in which information on the corresponding product is displayed.

It is also preferable that a third icon linked to a scene in which a displayed product is ordered is arranged, and in the product information scene a fourth icon linked to a moving picture scene restored to the original size is arranged.

To accomplish the objectives of the present invention, there is provided a method for displaying product information linked to a digital TV program comprising the steps of (a) displaying an AV scene of the digital TV program, (b) displaying a first icon overlapping the AV scene if there is product information linked to the AV scene which is currently reproduced, and (c) if the first icon is clicked on, displaying a first product information scene in which a reduced AV scene which is reduced from the AV scene, linked product information, a second icon for product information linked to the previously reproduced AV scene, and a third icon for product information linked to the reduced AV scene.

It is preferable that the method further comprises the step of (d) if the second icon is clicked on, displaying a second product information scene in which information on the corresponding product is displayed, or (d) if the third icon is clicked on, displaying a third product information scene in which information on the corresponding product is displayed.

To accomplish the objectives of the present invention, there is provided an apparatus comprising a receiving unit for receiving a digital TV program, a storage unit, a user input receiving unit for receiving a user input, an additional information extracting unit for extracting additional information linked to the digital TV program, storing the additional information in the storage unit, and generating an additional information scene based on the additional information stored in the storage unit, and a control unit for sending command to the additional information extracting unit to generate an additional information scene, in response to a user request which is input to the user input receiving unit.

It is preferable that the apparatus further includes a display unit for displaying the product information scene.

To accomplish the objectives of the present invention, there is provided an apparatus for displaying product information linked to a digital program comprising a receiving unit for receiving the digital TV program, a display unit, a presentation unit for outputting an AV scene of the digital TV program, a first product information scene in which a reduced AV scene which is reduced from the AV scene, linked product information, and a second icon for product information linked to a previously displayed AV scene are arranged, and a control unit for sending a command to the presentation unit to display a first icon overlapping the AV scene if there is product information linked to the current AV scene, and sending a command to the presentation unit to output the first product information scene if the first icon is clicked on.

It is also preferable that if the second icon is clicked on, the control unit sends a command to the presentation unit to output a second product information scene in which information on the corresponding product is displayed.

To accomplish the objectives of the present invention, there is provided an apparatus for displaying product information linked to a digital program comprising a receiving unit for receiving the digital TV program, a display unit, a presentation unit for outputting an AV scene of the digital TV program and a first icon, which is to be displayed together with the AV scene, to the display unit, and outputting a first product information scene, in which a reduced AV scene which is reduced from the AV scene, linked product information, a second icon for product information linked to a previously displayed AV scene, and a third icon for calling product information linked to the reduced AV scene are arranged together, to the display unit, and a control unit for sending a command to the presentation unit to output the first icon if there is product information linked to the AV scene, and sending a command to the presentation unit to output the first product information scene if the first icon is clicked on.

### BRIEF DESCRIPTION OF THE DRAWINGS

The above objects and advantages of the present invention will become more apparent by describing in detail preferred embodiments thereof with reference to the attached drawings in which:

FIG. 1 is a schematic diagram of an apparatus according to a preferred embodiment of the present invention;

FIG. 2 is a detailed block diagram of a set-top box;

FIG. 3 is a schematic diagram of a remote controller as an example of an apparatus for conveying user input;

FIGS. 4A through 7 are schematic diagrams of TV screens according to a preferred embodiment of the present invention;

FIGS. 8A through 11 are pictures of actual scenes which are implemented similarly or identically to the screens of FIGS. 4A through 7;

FIG. 12 is a flowchart for explaining a method for displaying product information linked to a digital TV program according to a first preferred embodiment of the present invention;

FIG. 13 is a flowchart for explaining an actual implementation example of the method of FIG. 12;

FIG. 14 is a flowchart for explaining a method for displaying product information linked to a digital TV program according to a second preferred embodiment of the present invention; and

FIG. 15 is a flowchart for explaining a method for displaying product information linked to a digital TV program according to a third preferred embodiment of the present invention.

### DESCRIPTION OF THE PREFERRED EMBODIMENTS

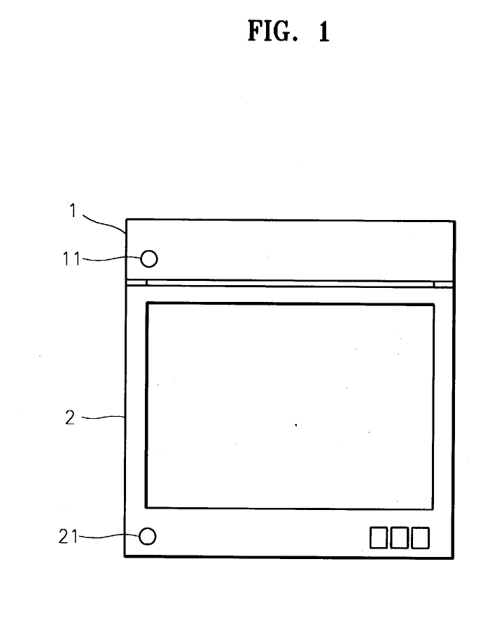

Referring to FIG. 1, the apparatus according to a preferred embodiment of the present invention has a set-top box 1 and a TV 2. Since the set-top box 1 has a user input receiving unit 11 for receiving a user input, the set-top box 1 receives a digital TV program selected by a user and additional information linked to the digital TV program. An Infrared (IR) receiving unit may be adopted as the user input receiving unit 11. The TV 2 displays the digital TV program input from the set-top box 1. The TV 2 has a user input receiving unit 21 for receiving a user input. Likewise, an IR receiving unit may be adopted as the user input receiving unit 21.

In addition, the set-top box 1 may be internally installed in the TV 2. At this time, the user input receiving unit 11 of the set-top box 1 and the user input receiving unit 21 of the TV 2 are implemented in one unit.

In the present embodiment, the digital TV program is formed with an MPEG stream. In the MPEG stream, a video packet, an audio packet, an additional data packet, and a navigation packet are multiplexed. The video packet includes a plurality of video frames, and the audio packet includes compressed audio data. The additional data packet includes additional information, and in particular, a time stamp. The time stamp includes a Presentation Time Stamp (PTS) and a Decoding Time Stamp (DTS). The PTS and DTS enable predetermined additional information to be synchronized to a corresponding video packet and/or audio packet and reproduced. The navigation packet includes navigation information needed in reproducing the corresponding digital TV program.

In the present invention, the meaning of additional information ‘linked to’ a digital TV program indicates a case in which additional information is physically received together with a digital TV program, and also indicates a case in which though additional information is received separately from the digital TV program, the additional information can be reproduced logically synchronized to the digital TV program. From the viewpoint of a data structure, the meaning of additional information ‘linked to’ a digital TV program indicates that additional information is formed so as to be reproduced linked to a video packet and/or an audio packet forming the digital TV program or to be reproduced linked to an object represented by a video frame.

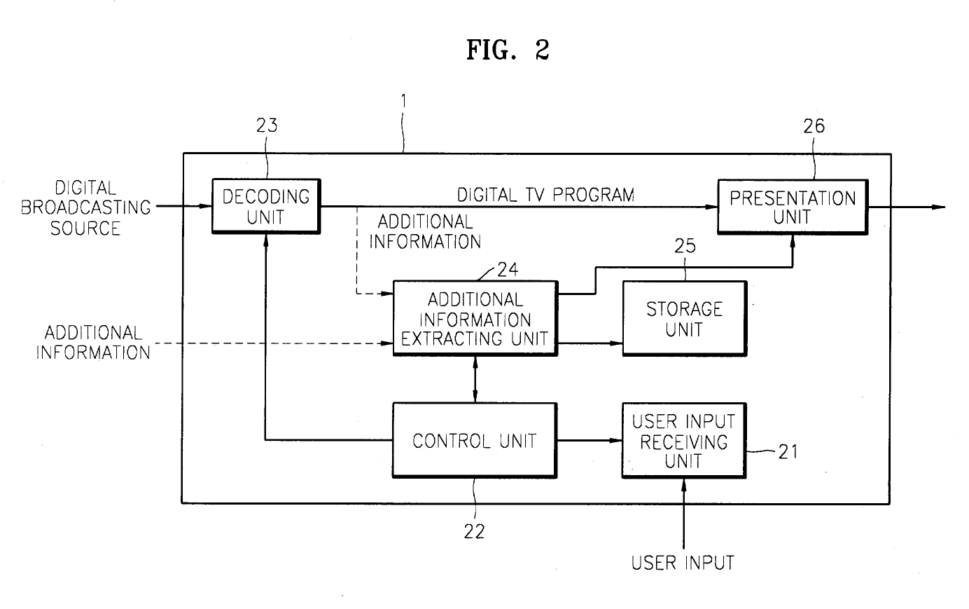

FIG. 2 is a detailed block diagram of a set-top box. Referring to FIG. 2, the set-top box 1 has a decoding unit 23, an additional information extracting unit 24, a storage unit 25, a control unit 22, a user input receiving unit 21, and a presentation unit 26. The decoding unit 23 receives an information signal, such as an AV signal, from an external digital broadcasting source, and then, according to a channel selection command input from the control unit 22, the decoding unit 23 separates and outputs a predetermined channel signal. The output signal includes a digital TV program. In order to input additional information linked to the digital TV program, the additional information linked to the digital TV program may be included in the signal output from the decoding unit 23, or may be input through another route such as the Internet. The additional information extracting unit 24 may extract predetermined additional information, and a video packet and/or an audio packet (video frame/audio data) linked to the additional information from the signal output from the decoding unit, and store the extracted data in the storage unit 25. Also, the additional information extracting unit 24 may receive additional information received through another route from the outside, extract the video packet and/or audio packet (video frame/audio data) linked to the additional information from the digital TV program, and store extracted data in the storage unit 25. The amount of video and/or audio data to be stored in the storage unit 25 is predetermined. For example, the amount may be determined as an amount which is reproduced for a few seconds. Also, the additional information extracting unit 24 generates an additional information scene based on the additional information and outputs the scene to the presentation unit 26. The additional information may be stored in the storage unit 25 by a store command of the control unit 22 according to the user input received in the user input receiving unit 21, or may be stored automatically in the storage unit 25 without a user input. If the additional information is stored by a user input, the additional information can be reproduced when the user wants, for example, when the additional information is wanted after the end of the corresponding program. Automatically storing the additional information is to show the additional information linked to the previous AV scene, which will be explained later. The process for reading additional information for the storage unit 25 and generating an additional information scene is performed by a reproducing command of the control unit 22 according to the user input received by the user input receiving unit 21.

The presentation unit 26 outputs an AV scene corresponding to the digital TV program, an icon for indicating the existence of a corresponding additional information, and/or an additional information scene. Then, on the screen of the TV 2, an AV scene is displayed, and if there is additional information, the icon for indicating the existence of the corresponding additional information, and/or the additional information scene. The icon may be included in the additional information, and received from the digital broadcasting source, or may be stored in advance in the presentation unit 26, and generated by the presentation unit 26.

If there is additional information linked to the AV scene display, the control unit 22 commands the presentation unit 26 to display a first icon overlapping the AV scene for a predetermined time. If the user clicks on the first icon, the control unit 22 sends control commands to the additional information extracting unit 24 and the presentation unit 26 to display a first product information scene in which a reduced AV scene, additional information, and a second icon on additional information linked to an AV scene which was previously displayed are arranged. Also, if the user clicks on the second icon, the control unit 22 sends control commands to the additional information extracting unit 24 and the presentation unit 26 to display a second product information scene in which corresponding additional information is displayed.

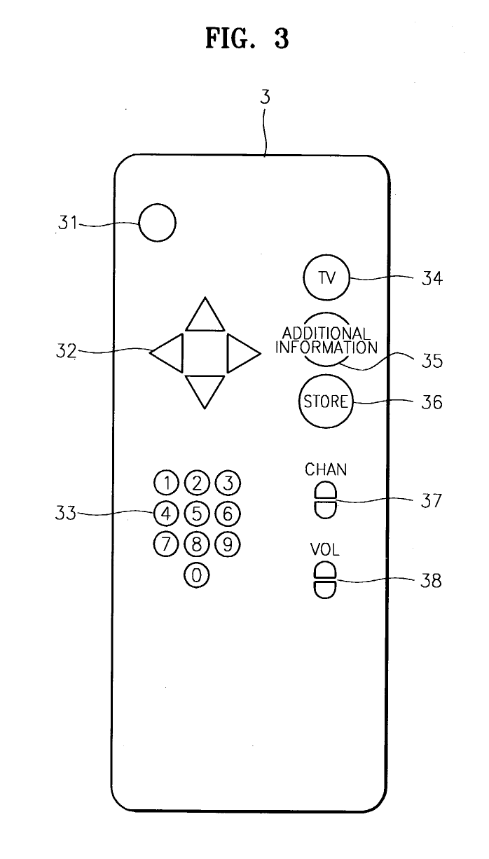

FIG. 3 is a schematic diagram of a remote controller as an example of an apparatus for conveying user input. Referring to FIG. 3, the remote controller according to the present embodiment has an on/off button 31, a four-direction key 32, a number key pad 33, a TV button 34, an additional information button 35, a store button 36, a channel change key 37, and a volume key 38. In particular, the four-direction key 32 is used to move a pointer (cursor) which is displayed on the screen of the TV 2. The store button 36 is used to store additional information (and a corresponding AV scene) linked to the digital TV program. Accordingly, the user stores additional information in advance, and can reproduce the additional information when it is desired.

The remote controller 3 internally has' an infrared ray generating unit (not shown). If a button or key is pressed, a corresponding infrared ray signal is generated and transmitted to the set-top box 1 or the user input receiving unit 11 or 21 of the TV 2.

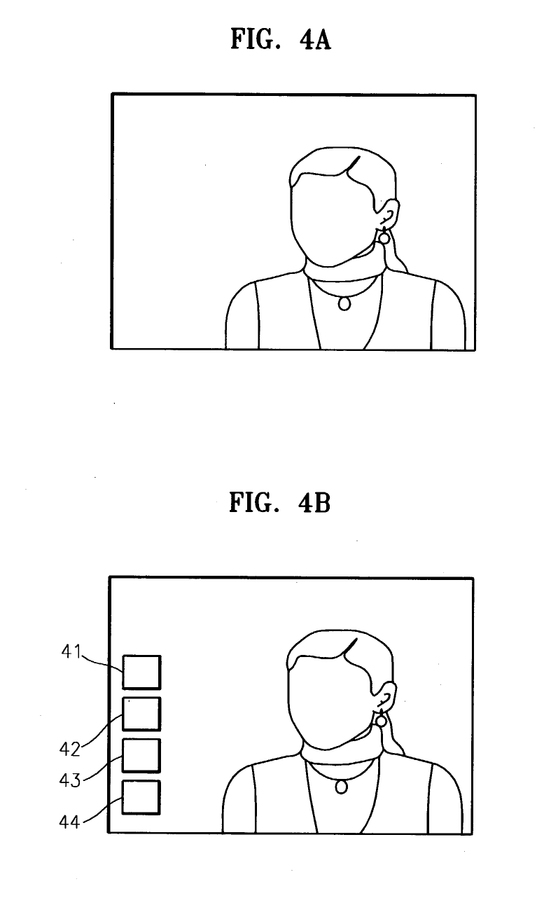

FIGS. 4A through 7 are schematic diagrams of TV screens according to a preferred embodiment of the present invention.

In the present embodiment, additional information is product information. Product information stored in the storage unit 25 is information related to an object (a cast, etc.) displayed in a corresponding AV scene, and contains image and purchase information of a corresponding product.

Referring to FIG. 4A, an AV scene is displayed. The AV scene includes a moving picture layer. Also, the AV scene may further include a transparent layer containing information on an area for user's clicking. The transparent layer having information on the motion of the moving picture layer moves together with the moving picture, and if the user clicks on the corresponding clicking area, the transparent layer senses the clicking. Also, if there is a transparent layer, when a corresponding object is clicked on, a corresponding product information scene may be displayed.

If there is product information linked to the AV scene which is currently displayed, an icon layer in which corresponding icons 41 through 44 are displayed is displayed overlapping the AV scene as shown in FIG. 4B. Icons correspond to objects that can be clicked on in the current AV scene. That is, icons correspond to the objects displayed in the AV scene, including earrings, a necklace, a sweater, and a cardigan.

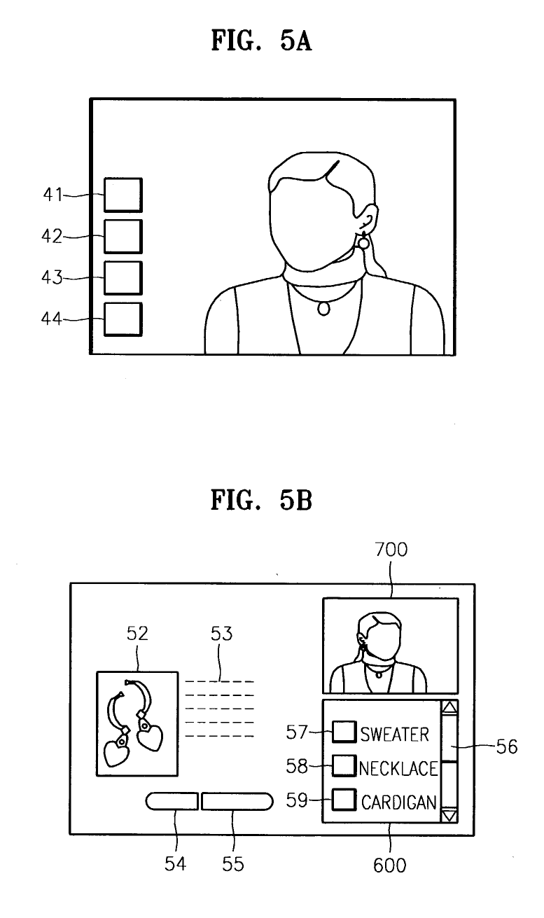

Referring to FIG. 5A, which is the same as FIG. 4B, if the user clicks on an earring icon 41 among the icons 41 through 44 displayed on the AV scene with the remote controller 3, the product information scene of FIG. 5B is displayed. In the product information scene of FIG. 5B, image information 52 and purchase information 53 of the earrings are displayed. In the bottom of the scene of FIG. 5B, a product order icon 54 for calling a scene for ordering the earrings, and a return icon 55 for restoring the AV scene to the previous size are arranged. If the product order icon 54 is clicked on, the corresponding product can be directly purchased by accessing a product selling server (not shown), for example, through a network connection unit (not shown) installed in the TV 2. In the top right hand corner, a reduced AV scene area 700 is arranged. Below the reduced AV scene area 700, an icon scene area 600 is arranged. In the icon scene area 600, icons for indicating product information related to objects displayed in the reduced AV scene area 700 which is currently displayed, or in the AV scene (including a reduced AV scene area 700) which was previously displayed, are displayed. In the icon scene area 600, icons 57 through 59 for indicating information on the objects which is currently displayed in the reduced AV scene area 700. That is, information on the sweater, the necklace, and the cardigan, are displayed. In the right part, a scroll bar is arranged so that icons 57 through 59 can be scrolled.

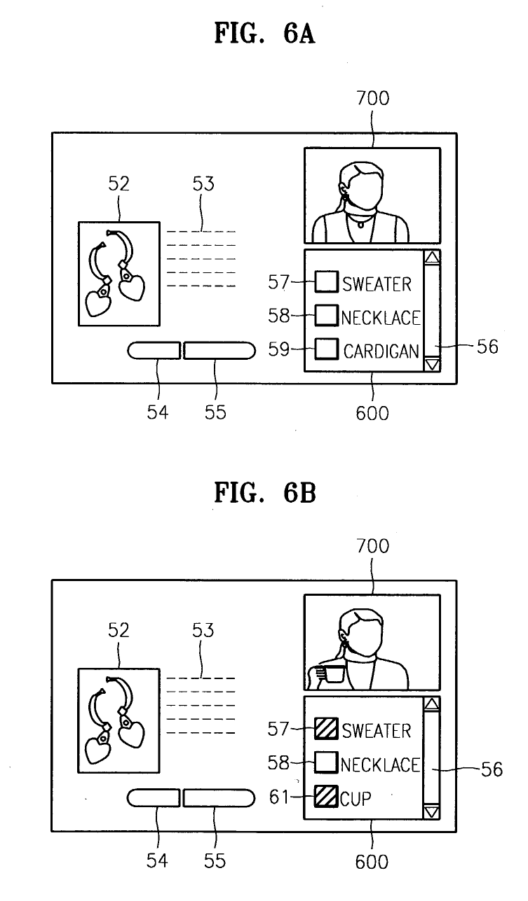

Referring to FIG. 6A, which is the same as FIG. 5B, if in the product information scene, the object displayed in the reduced AV scene 700 changes (if the object disappears, or a new object appears), the icon scene 600 also changes so as to correspond to the change. If the necklace in the reduced AV scene area 700 disappears and a cup newly appears, an icon 61 for the cup is newly displayed in the icon scene area 600. In addition, icons (icon 58 for displaying information about the necklace) for indicating information related to the object of the AV scene which was previously displayed (and/or the reduced AV scene area 700) and icons for indicating information related to the object of the current reduced AV scene area 700 (icons 57 and 61 for the sweater and the cup) are differently displayed such that the user can distinguish.

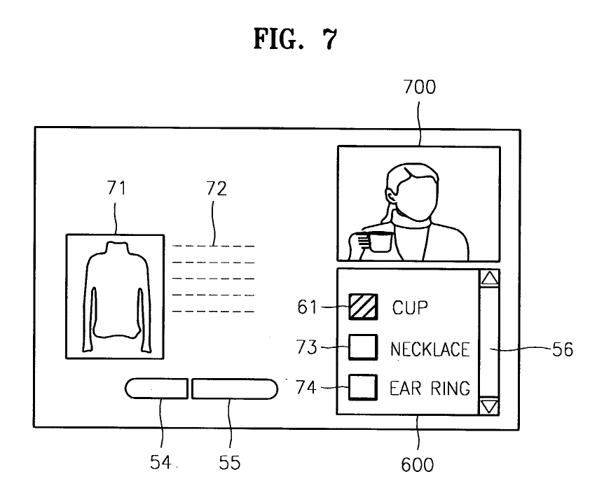

Referring to FIG. 7, the product information scene is shown when the user clicks on the sweater icon 57 displayed in product information scene of FIG. 6B. The product information scene has image information 71 and purchase information 72 of the sweater. Likewise, in the bottom, a product order icon 54 for calling a scene for ordering the sweater and a return icon 55 for restoring the AV scene to the previous size are arranged. In the icon scene area 600, the icon 61 for the cup which is an object currently displayed in the reduced AV scene area 700, and icons 73 and 74 for the necklace and the earrings which are objects previously displayed are arranged. The user can scroll the scroll bar 56 so as to watch icons for objects displayed before the necklace and earrings, and by clicking on an icon, can confirm corresponding product information.

Here, the reduced AV scene area 700 may not be displayed. Also, when product information and a corresponding AV scene are stored and then reproduced for watching, a still picture containing the corresponding object in the AV scene area 700 may be displayed. Also, whenever a pointer (cursor) is placed on an icon, a moving or still picture containing an object corresponding to the icon may be linked and displayed in the AV scene area 700. For other formation of the screen, ordinary changes are available.

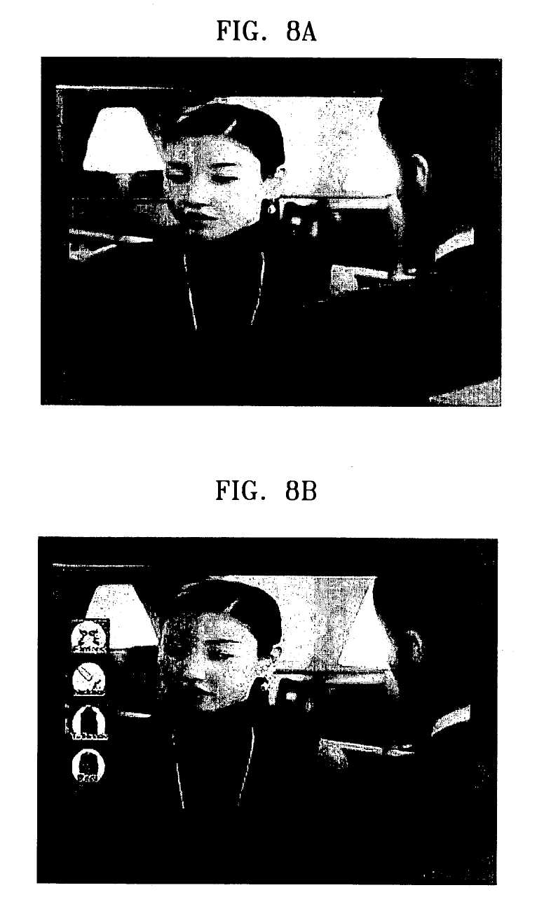

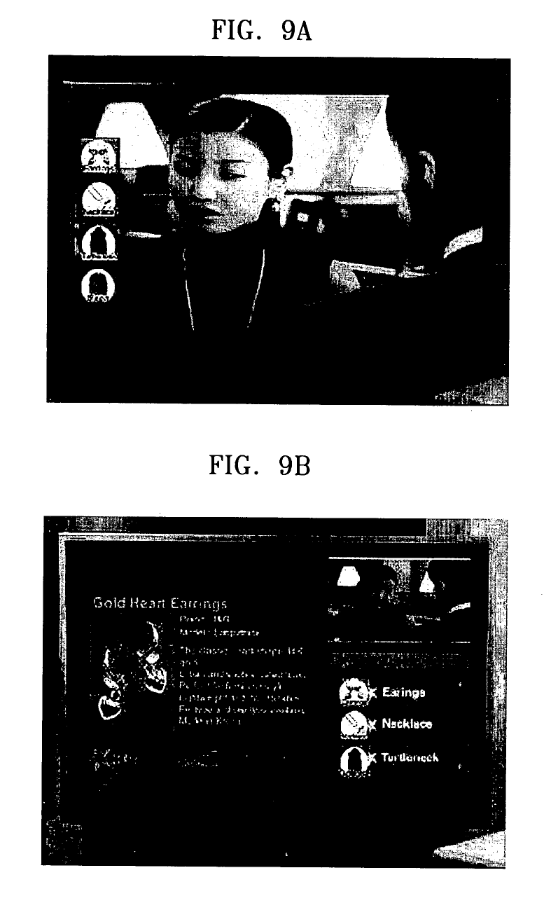

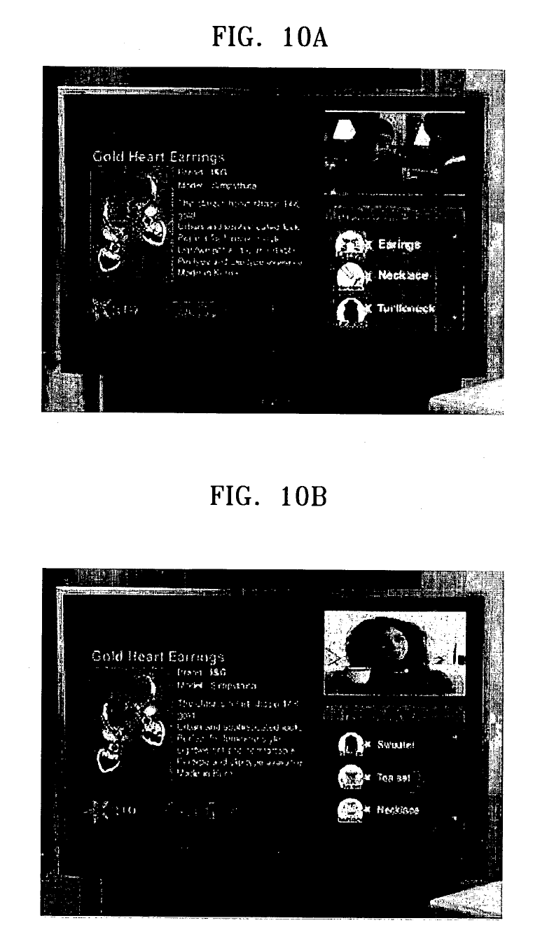

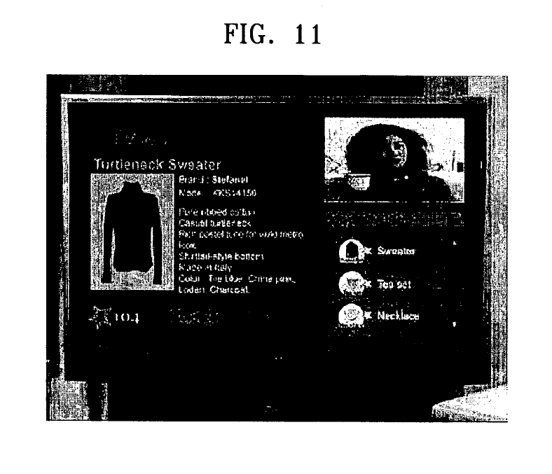

FIGS. 8A through 11 are pictures of actual scenes which are implemented similarly or identically to the screens of FIGS. 4A through 7. In these figures, FIG. 9A is the same as FIG. 8B and FIG. 10A is the same as FIG. 9B. Referring to FIGS. 8A through 11, an asterisk mark is attached only to an icon for displaying product information linked to the current object and not to an icon for the previous object so as to distinguish the present object from the previous object.

Based on the above-described structure, a method for displaying additional information according to a preferred embodiment of the present invention will now be explained.

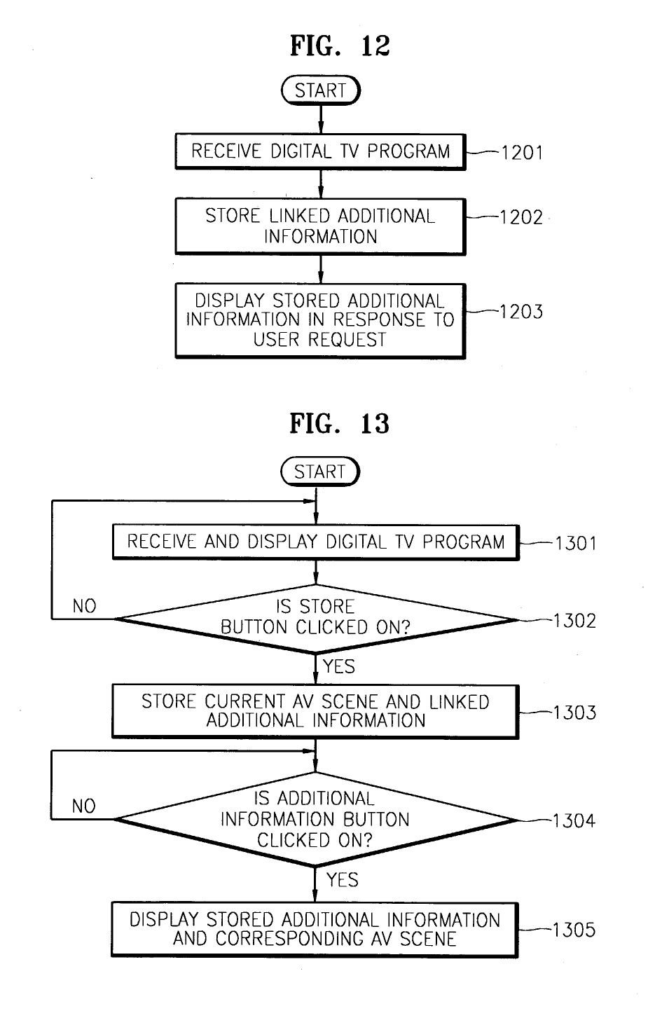

FIG. 12 is a flowchart for explaining a method for displaying product information linked to a digital TV program according to a first preferred embodiment of the present invention.

Referring to FIG. 12, the set-top box 1 receives a digital TV program in step 1201. Next, additional information linked to the digital TV program is stored in step 1202. In response to a request of the user, stored product information is displayed on the TV 2 in step 1203.

More specifically, the set-top box 1 receives the digital TV program, displays the digital TV program on the TV 2, and in response to the user's request, stores additional information linked to the digital TV program, or additional information linked to an AV scene which is currently displayed. Then, in response to a user request, product information, linked video packets/video frames are displayed together on the TV 2.

FIG. 13 is a flowchart for explaining an actual implementation example of the method of FIG. 12.

Referring to FIG. 13, the set-top box 1 receives the digital TV program and displays the digital TV program on the TV 2 in step 1301. If the user clicks on the store button 36 of the remote controller 3 in step 1302, an AV scene which is currently displayed and additional information linked to the AV scene are stored in step 1303. More accurately, since the AV scene indicates a scene which is shown on the TV 2, what is actually stored is corresponding video packets/video frames and/or audio packets.

If the user clicks on the additional information button 35 of the remote controller in step 1304, the set-top box 1 displays stored additional information and a corresponding AV scene on the TV 2 in step 1305.

For example, a shopping basket mode is arranged in a menu scene of the TV. If additional information is product information, and the user selects the shopping basket mode during or after reproducing the digital TV program, a product list for showing outline information of stored product information is displayed together with information (title, broadcasting date, contents, etc.) on the corresponding digital TV program. The product list may include the name of products, or image information such as thumbnails. If a given product is clicked on in the product list, a product information scene containing corresponding product information is displayed. In the product information scene, image information and purchase information of the corresponding product are displayed. In addition, linked video packets/video frames may be displayed.

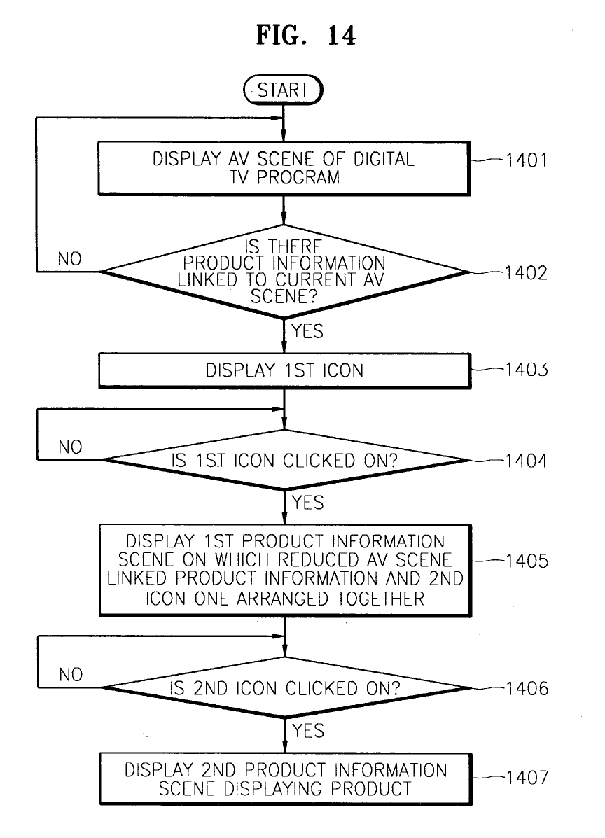

FIG. 14 is a flowchart for explaining a method for displaying product information linked to a digital TV program according to a second preferred embodiment of the present invention.

Referring to FIG. 14, the set-top box 1 displays an AV scene of the digital TV program on the TV 2 in step 1401. If there is product information linked to the current AV scene in step 1402, a first icon for information on the corresponding product is displayed overlapping the AV scene in step 1403. If the user clicks on the first icon using the selection key 32 and additional information button 35 of the remote controller 3 in step 1404, a first product information scene in which a reduced AV scene, product information, and a second icon are arranged is displayed in step 1405. If the user clicks on the second icon in step 1406, a second product information scene in which product information linked to the previous AV scene is displayed in step 1407.

In the product information scene, a third icon linked to a scene for ordering the displayed product, and a fourth icon linked to the AV scene which is restored to the original size are arranged. Also, image information and purchase information of the corresponding product are displayed.

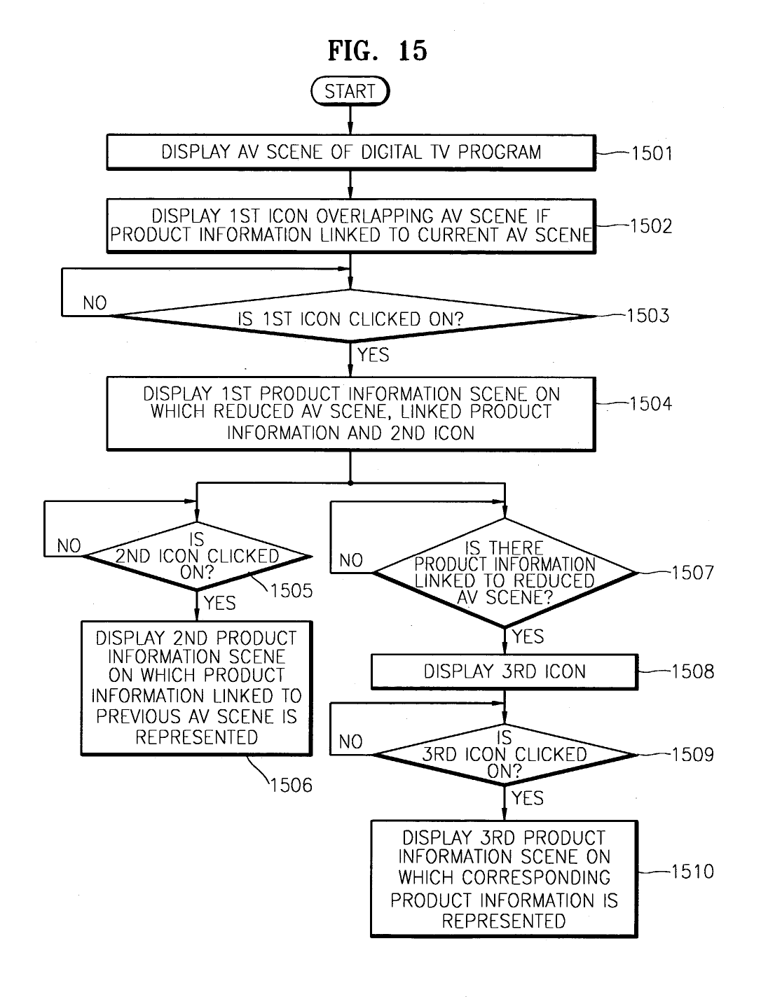

FIG. 15 is a flowchart for explaining a method for displaying product information linked to a digital TV program according to a third preferred embodiment of the present invention.

Referring to FIG. 15, the set-top box 1 displays an AV scene of the digital TV program in step 1501. If there is product information linked to the current AV scene, a first icon for information on the corresponding product is displayed overlapping the AV scene in step 1502. If the user places the pointer (cursor) on an icon with the selection key 32 of the remote controller 3 and clicks on the first icon by pressing the additional information button 35 in step 1503, the set-top box 1 displays a first product information scene in which a reduced AV scene, product information, and a second icon are arranged in step 1504. If the user clicks on the second icon in step 1505, a second product information scene containing product information linked to the previous AV scene is displayed in step 1506.

If there is product information linked to the reduced AV scene in step 1507, a third icon is displayed in step 1508. If the user clicks on the third icon in step 1509, a third product information scene containing information on the corresponding product is displayed in step 1510.

Meanwhile, though the remote controller 3 is explained as the user input receiving unit in the above embodiments, a variety of apparatuses such as a keyboard may be the user input receiving unit.

As described above, according to the present invention, a method and apparatus for displaying additional information linked to a digital TV program are provided. Therefore, a user can use a user-friendly interface for additional information linked to the digital TV program. In addition, linked additional information may be stored and when necessary can be reproduced. Furthermore, product information on an object which was already broadcast can be watched later.

What is claimed is:

1. A method for displaying product information linked to a digital TV program comprising the steps of:
(a) extracting and storing the product information; and
(b) displaying the stored product information in response to a user request.

2. The method of claim 1, wherein step (a) comprises the steps of:
(a1) receiving and displaying the digital TV program; and
(a2) storing product information linked to the digital TV program displayed in step (a1) in response to the user request.

3. The method of claim 2, wherein step (b) further comprises the step:
(b1) displaying stored product information and a linked AV scene together.

4. The method of claim 3, wherein the product information includes image information and purchase information of the corresponding product.

5. A method for displaying product information linked to a digital TV program comprising the steps of:
(a) displaying an AV scene of the digital TV program;
(b) displaying a first icon overlapping the AV scene if there is product information linked to the current AV scene; and
(c) if the first icon is clicked on, displaying a first product information scene in which a reduced AV scene which is reduced from the AV scene, linked product information, and a second icon for product information linked to the previously displayed AV scene are arranged.

6. The method of claim 5, further comprising the step:
(d) if the second icon is clicked on, displaying a second product information scene in which information on the corresponding product is displayed.

7. The method of claim 6, wherein a third icon linked to a scene in which a displayed product is ordered is arranged.

8. The method of claim 7, wherein, in the product information scene, a fourth icon linked to a moving picture scene restored to the original size is arranged.

9. The method of claim 6, wherein, in the product information scene, image information and purchase information of the product are displayed.

10. A method for displaying product information linked to a digital TV program comprising the steps of:
(a) displaying an AV scene of the digital TV program;
(b) displaying a first icon overlapping the AV scene if there is product information linked to the AV scene which is currently reproduced; and
(c) if the first icon is clicked on, displaying a first product information scene in which a reduced AV scene which is reduced from the AV scene, linked product information, a second icon for product information linked to the previously reproduced AV scene, and a third icon for product information linked to the reduced AV scene are arranged.

11. The method of claim 10, further comprising the step of:
(d) if the second icon is clicked on, displaying a second product information scene in which information on the corresponding product is displayed.

12. The method of claim 10, further comprising the step of:
(d) if the third icon is clicked on, displaying a third product information scene in which information on the corresponding product is displayed.

13. An apparatus comprising:
a receiving unit for receiving a digital TV program;
a storage unit;
a user input receiving unit for receiving a user input;
an additional information extracting unit for extracting additional information linked to the digital TV program, storing the additional information in the storage unit, and generating an additional information scene based on the additional information stored in the storage unit; and
a control unit for sending a command to the additional information extracting unit to generate an additional information scene, in response to a user request which is input to the user input receiving unit.

14. The apparatus of claim 13, further comprising:
a display unit for displaying a product information scene.

15. The apparatus of claim 14, wherein the product information includes image information and purchase information of the corresponding product.

16. An apparatus for displaying product information linked to a digital TV program comprising:
a receiving unit for receiving the digital TV program;
a display unit;
a presentation unit for outputting an AV scene of the digital TV program, an a first product information scene in which a reduced AV scene which is reduced from the AV scene, linked product information, and a second icon for product information linked to a previously displayed AV scene are arranged; and
a control unit for sending a command to the presentation unit to display a first icon overlapping the AV scene if there is product information linked to the current AV scene, and sending a command to the presentation unit to output the first product information scene if the first icon is clicked on.

17. The apparatus of claim 16, wherein if the second icon is clicked on, the control unit sends a command to the presentation unit to output a second product information scene in which information on the corresponding product is displayed.

18. An apparatus for displaying product information linked to a digital TV program comprising:
a receiving unit for receiving the digital TV program;
a display unit;
a presentation unit for outputting an AV scene of the digital TV program and a first icon, which is to be displayed together with the AV scene, to the display unit, and outputting a first product information scene, in which a reduced AV scene which is reduced from the AV scene, linked product information, a second icon for product information linked to a previously displayed AV scene, and a third icon for calling product information linked to the reduced AV scene are arranged together, to the display unit; and
a control unit for sending a command to the presentation unit to output the first icon if there is product information linked to the AV scene, and sending a command to the presentation unit to output the first product information scene if the first icon is clicked on.
